(19) United States
(12) Patent Application Publication
(10) Pub. No.: US 2024/0365805 A1
(43) Pub. Date: Nov. 7, 2024

(54) ROASTED COFFEE

(71) Applicant: SOCIETE DES PRODUITS NESTLE S.A., Vevey (CH)

(72) Inventors: KEVAN ARTHUR ELSBY, Warwickshire (GB); SEAN MACKAY MURPHY, Cossonay-Ville (CH); MIKAEL JOSE NOIRA GUERRA, Gingins (CH); CELINE SARRAZIN-HORISBERGER, Suchy (CH); LUIGI POISSON, Courgevaux (CH); TOMAS DAVIDEK, Chenens (CH); STEFAN SPRENG, Orbe (CH)

(21) Appl. No.: 18/568,065

(22) PCT Filed: May 25, 2022
(86) PCT No.: PCT/EP2022/064192

§ 371 Date: Dec. 7, 2023

(30) Foreign Application Priority Data
Jun. 9, 2021 (EP) 21178416.0

(51) Int. Cl. A23F 5/02; A23F 5/04

(52) U.S. Cl. CPC A23F 5/02; A23F 5/046

(57) ABSTRACT

The present invention relates to a process for roasting coffee, in particular to roasting unroasted coffee beans in the presence of superheated steam followed by roasting without steam. Further aspects of the invention are a roast coffee and a container for use in a beverage preparation device, the container containing the roast coffee.

### FIELD OF THE INVENTION

The present invention relates to a process for roasting coffee, in particular to roasting coffee beans in the presence of superheated steam followed by roasting without steam. Further aspects of the invention are a roast coffee and a container for use in a beverage preparation device, the container containing the roast coffee.

### BACKGROUND OF THE INVENTION

The characteristic aroma and taste of coffee is developed during the roasting of the coffee beans. Lighter roasts are normally associated with higher perceived acidity and more fruity and winey aroma notes, whereas darker roasts develop more body and more roasty notes.

Coffee drinkers do not all share the same preferences in terms of coffee aroma and taste. Indeed, many coffee drinkers appreciate the variety of sensory experiences that coffee can provide, with different bean types, origins, blends and roasting processes all playing a role.

It is desirable when roasting coffee commercially to be able to modulate the taste and aroma of coffee. This can be to create new sensory characteristics or to maintain constant sensory characteristics for a coffee product over time, compensating for the changing seasonal availability of different coffee beans. Commercially it is important to have roasting processes which can modulate taste and aroma but are also economical to run and deliver good yields.

Hence, there is a persisting need in the industry to find improved solutions for roasting coffee.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”.

### SUMMARY OF THE INVENTION

An object of the present invention is to improve the state-of-the-art. The object of the present invention is achieved by the subject matter of the independent claims. The dependent claims further develop the idea of the present invention.

Accordingly, the present invention provides in a first aspect a process for roasting coffee beans comprising roasting unroasted coffee beans in the presence of superheated steam at a pressure greater than 9.5 bar for a period between 20 and 900 seconds followed by roasting without steam at a bean temperature of between 180° C. and 260° C. for a period between 20 and 900 seconds.

In a second aspect, the invention provides a roast coffee having a weight ratio of (E)-β-damascenone to 2,3-diethyl-5-methylpyrazine of greater than 0.7.

A third aspect of the invention relates to a container for use in a beverage preparation device, the container containing the roast coffee of the invention.

Roasting coffee with steam can alter the taste and aroma of coffee. However, steam roasted coffee tends to be much more sour. Surprisingly, it has been found by the inventors that roasting coffee in two stages; the first roasting stage being with superheated steam at a high pressure and the second roasting stage roasting being without steam, provides an enhanced capability to modulate the coffee into different taste regions, generating fine acidity but without excessive sourness. In particular, the resulting roasted coffee has high levels of aroma compounds associated with desirable cooked fruit or jam notes such as damascenone, combined with low levels of aroma compounds associated with earthy notes such pyrazines that are characteristic of darkly roasted robusta coffees. This effect occurs for both robusta and arabica coffee beans. Advantageously, the coffee can be extracted with high brew solids after roasting with the process of the invention, but without unpleasant sourness.

### DETAILED DESCRIPTION OF THE INVENTION

Consequently, the present invention relates in part to a process for roasting coffee beans comprising roasting unroasted coffee beans in the presence of superheated steam at a pressure greater than 9.5 bar for a period between 20 and 900 seconds followed by roasting without steam at a bean temperature of between 180° C. and 260° C. for a period between 20 and 1200 seconds.

Unroasted coffee beans are sometimes referred to as green coffee beans. In the context of the present invention, unroasted coffee beans are coffee beans which have not been subjected to a temperature sufficiently high to initiate roasting. In an embodiment, the unroasted coffee beans have not been heated to temperatures above 110° C. For example, the unroasted beans may not have been heated above 90° C., for example not above 80° C., for example not above 70° C., for example not above 60° C., for further example not above 50° C.

Roasting without steam may be performed in a suitable roasting device, for example a drum roaster, a fluidized bed roaster or a paddle roaster. The roasting without steam may be performed in a separate device to that used for roasting in the presence of superheated steam. In an embodiment, the roasting without steam is performed in a fluidized bed roaster or a paddle roaster. The roasting without steam may be performed under an inert atmosphere. The roasting without steam may be performed at, or close to, atmospheric pressure.

In an embodiment, roasting coffee beans in the presence of superheated steam may be performed in perforated rotatable drum in a pressurizable chamber.

Many consumers expect the coffee they drink to contain no ingredients other than coffee beans. In an embodiment, the unroasted coffee beans may be roasted in the presence of superheated steam in the absence of any non-coffee ingredients such as added sugars. In an embodiment, the step of roasting the beans without steam may be performed in the absence of any non-coffee ingredients such as added sugars. In a further embodiment, all roasting steps in the process for roasting coffee beans are performed in the absence of non-coffee ingredients such as added sugars.

In an embodiment, the unroasted coffee beans may be roasted in the presence of superheated steam in the absence of any non-coffee bean component, such as other components of coffee cherries. In an embodiment, the step of roasting the beans without steam may be performed in the absence of any non-coffee bean component such as other components of coffee cherries. In a further embodiment, all roasting steps in the process for roasting coffee beans are performed in the absence of any non-coffee bean component such as other components of coffee cherries.

In an embodiment the superheated steam has a pressure greater than 9.5 bar, for example a pressure greater than 10 bar, for example greater than 11 bar, for example greater than 12 bar, for example greater than 13 bar, for example greater than 14 bar, for further example greater than 15 bar. The superheated steam may have a pressure from 9.5 bar to 20 bar, for example from 10 bar to 18 bar, for example from 12 bar to 17 bar, for further example from 13 bar to 16 bar.

Pressures given in this document with the units “bar”, refer to absolute pressure, sometimes written bara or bar (a). 1 bar is equal to 100 kPa.

The temperature of the steam must be such that the steam is in a superheated state at the pressure of the steam, the steam supply being sufficient to maintain a superheated steam atmosphere. Pressure-enthalpy state diagrams for steam are widely available. Subject to being in a superheated state, the steam temperature may be from 180° C. to 330° C., for example from 220° C. to 320° C., for further example from 250° C. to 310° C. For example, the superheated steam may be at a pressure of 15 bar and a temperature of 300° C.

In an embodiment, the unroasted coffee beans may be roasted in the presence of superheated steam to a final bean temperature of between 180° C. to 320° C., for example from 190° C. to 300° C., for further example from 200° C. to 280° C.

In an embodiment, the moisture content of the coffee beans after being roasted in the presence of superheated steam is lower than the moisture content of the unroasted beans. Superheated steam is “dry” in the sense that it does not contain water in the liquid phase. Simply steaming the beans before roasting, for example with saturated steam, does not provide the desired modulation in taste, indeed high levels of bean moisture (e.g. greater than or equal to 20 wt. % moisture in the bean) such as may be the result of steaming in wet steam drive unwanted sensory attributes such as undesired sourness and generation of sensorially undesirable compounds when the beans are subjected to roasting temperatures.

In an embodiment, the unroasted coffee beans are roasted in the presence of superheated steam for a period between 20 and 900 seconds, for example between 30 and 300 seconds, for example between 50 and 250 seconds, for example between 60 and 200 seconds, for example between 80 and 150 seconds, for further example between 90 and 130 seconds.

In an embodiment, the roasting without steam may be at a bean temperature of between 185° C. and 230° C., for example between 190° C. and 210° C. In an embodiment, the roasting without steam may be for a period between 40 and 300 seconds, for example between 40 and 900 seconds, for example between 50 and 150 seconds, for example between 60 and 120 seconds, for example between 80 and 110 seconds, for further example between 180 and 240 seconds.

In an embodiment, the process for roasting coffee beans comprises roasting unroasted coffee beans in the presence of superheated steam at a pressure greater than 12 bar for a period between 80 and 150 seconds followed by roasting without steam at a bean temperature of between 180° C. and 220° C. for a period between 200 and 220 seconds.

Advantageously the process of the invention is able to generate tastes and aromas normally associated with lightly roasted arabica beans from robusta beans. However, the coffee beans according to the invention may be arabica coffee beans, robusta coffee beans or combinations of these. Coffee beans are the seeds of the coffee plant (Coffea). By arabica coffee beans are meant coffee beans from arabica coffee plants (Coffea arabica) and by robusta coffee beans are meant beans from robusta coffee plants (Coffea canephora).

In an embodiment, the roasted coffee beans may be ground, for example the coffee beans may be ground after roasting without steam.

Beverage preparation devices (for example beverage preparation machines) which accommodate extractable portioned ingredients provide a convenient method of preparing beverages. Such portioned ingredients are generally packed in a container, configured for example as a pod, pad, sachet, pouch, capsule or the like. In an embodiment, the roasted coffee beans (for example roasted and ground coffee beans) are filled into a container, the container being for the preparation of a beverage when inserted into a beverage preparation device. The container may for example be a beverage capsule, among other configurations.

To best optimize the sensory characteristics of coffee beans, the roasting applied to a proportion of the beans in the final blend may be different from the roasting applied to other beans in the blend. For example, in a blend of beans from different origins and/or different types the different origins/types of beans may be roasted separately under conditions to optimize the final flavour and aroma. In an embodiment, the beans after roasting without steam are blended with further coffee beans that have been roasted under different conditions. In an embodiment, the process for roasting coffee beans comprises
a) roasting a first type of unroasted coffee beans in the presence of superheated steam at a pressure greater than 9.5 bar for a period between 20 and 900 seconds followed by roasting without steam at a bean temperature of between 180° C. and 260° C. for a period between 20 and 1200 seconds;
b) roasting a second type of unroasted coffee beans; and
c) blending the roasted first and second types of coffee beans.

The roasting of the second type of unroasted coffee beans may, for example, be performed without steam, such as at a bean temperature of between 180° C. and 260° C. for a period between 20 and 1200 seconds. The roasting of the second type of coffee may, for example, be by roasting unroasted coffee beans in the presence of superheated steam at a pressure greater than 9.5 bar for a period between 20 and 900 seconds followed by roasting without steam at a bean temperature of between 180° C. and 260° C. for a period between 20 and 1200 seconds.

In an embodiment, the roast colour of the roasted beans obtained in step a) is at least 20 CTN higher than the roast colour of the roasted beans obtained in step b). In a further embodiment, the first type of unroasted coffee beans is from a different origin and/or a different coffee species than the second type of unroasted coffee beans.

Roast bean colour may be expressed in CTN units. CTN roast colour may vary between 0 and 200 and is determined by measuring the intensity of Infrared (IR) light (904 nm) that is back scattered by the sample when measured with a spectrophotometer, such as Neuhaus Neotec's ColorTest II®. The spectrophotometer illuminates the surface of the ground sample with monochromatic IR light at a wavelength of 904 nm from a semi-conductor source. A photo-receiver, which has been calibrated, measures the amount of light reflected by the sample. The mean value series of measurement is calculated and displayed by electronic circuit. The colour of the coffee beans is altered by its roast level. For example, green coffee beans have typically a CTN of above 200, extremely lightly roasted coffee beans have typically a CTN of around 150, lightly roasted coffee beans have typically a CTN around 100 and medium-dark coffee beans have typically a CTN of around 70. Very dark roasted coffee beans have typically a CTN around 45.

The first type of coffee beans may be high quality beans with an intrinsic fruity/floral aroma and a fine acidity. The second type of coffee beans, being from a different origin and/or a different coffee species than the first type of coffee beans may be of a lower quality grade than the first type of coffee beans. The second type of coffee beans may for example be dry processed robusta or dry processed Brazilian Arabica beans. By “different origin” is meant that the beans are grown in a different geographical region or country. Colombian, Kenyan, Costa Rican, Nicaraguan and Brazilian are examples of origins. The first type of coffee beans may be selected from the group consisting of Colombian Arabica, Kenyan Arabica, Central American Arabica (for example Costa Rican or Nicaraguan), high quality Brazilian arabica, highest quality robusta and combinations of these. For example, the first type of coffee beans may be selected from the group consisting of Colombian Arabica, Kenyan Arabica, Central American arabica (for example Costa Rican or Nicaraguan), high quality Brazilian arabica and combinations of these. For further example the first type of coffee beans may be Colombian arabica or Kenyan arabica. In an embodiment the first type of coffee beans are beans selected from the group consisting of Colombian arabica, Kenyan arabica, Costa Rican arabica, Nicaraguan arabica coffee beans and combinations of these.

The two stages of roasting of the process of the invention do not have to be performed in the same physical location. Roasters capable of roasting with superheated steam are generally more expensive than roasters that roast without steam. It may make economic sense to have a central facility roasting beans in the presence of superheated steam and then ship these steam roasted beans to a series of other sites, for example sites close to the sales location, to perform the roasting without steam. The roasting without steam may for example be performed at home or at a retail premises. At home or in retail premises, the provision of partially roasted beans roasted with steam widens the range of coffees with attractive aromas that can be offered. The beans would typically be packed into containers for the transport. In an embodiment, the beans roasted in the presence of superheated steam are packed into containers and transported to at least one other location before being roasted without steam.

An aspect of the invention provides a process for roasting coffee beans comprising roasting unroasted coffee beans in the presence of superheated steam at a pressure greater than 9.5 bar for a period between 20 and 900 seconds followed by packing into a container. For example, the unroasted coffee beans may be roasted to a colour having a CTN of greater than 100.

A further aspect of the invention is the use of coffee beans that have been partially roasted by being subjected to roasting in the presence of superheated steam for subsequent roasting at home or at retail premises.

A still further aspect of the invention is a process for roasting coffee beans comprising roasting unroasted coffee beans in the presence of superheated steam for a period between 20 and 900 seconds (for example between 30 and 250 seconds, for example between 50 and 250 seconds, for example between 60 and 200 seconds, for example between 80 and 150 seconds, for further example between 90 and 130 seconds) followed by roasting without steam at a bean temperature of between 180° C. and 260° C. for a period between 20 and 1200 seconds (for example between 120 and 500 seconds), grinding the beans and filling the ground beans into a container, the container being for the preparation of a beverage when inserted into a beverage preparation device.

The inventors were surprised to find that roast coffee according to the invention has improved sensory attributes confirmed by aroma chemistry atypical of the types of beans roasted by only conventional thermal roasting. The roast coffee has lower levels of aroma compounds associated with earthy notes such as alkyl pyrazines that are characteristic of darkly roasted robusta coffees, and higher levels of aroma compounds associated with jam-fruity notes such as (E)-β-damascenone. This effect occurs for both robusta and arabica coffee beans. An aspect of the invention provides a roast coffee (for example a roast and ground coffee) having a weight ratio of (E)-β-damascenone to 2,3-diethyl-5-methylpyrazine of greater than 0.7, for example greater than 0.8, for example greater than 0.85, for example greater than 0.9, for example greater than 1.0, for example between 0.7 and 5.0, for further example between 0.8 and 4.0, for example between 0.9 and 3.5. (E)-β-damascenone is an aroma molecule which provides jam-fruity notes. 2,3-diethyl-5-methylpyrazine is an aroma molecule which provides earthy notes.

In an embodiment, the roast coffee of the invention has a weight ratio of dimethyl trisulfide to 2,3-diethyl-5-methylpyrazine greater than 0.2, for example greater than 0.21, 0.22, 0.23, 0.24, 0.25, 0.26, 0.27, 0.28, 0.29, 0.30, 0.32, 0.34, 0.36, 0.38, 0.40 or 0.42. In an embodiment, the roast coffee of the invention has a weight ratio of dimethyl trisulfide to 2,3-diethyl-5-methylpyrazine between 0.2 and 0.6. An increased ratio of dimethyl trisulfide to 2,3-diethyl-5-methylpyrazine is associated with enhanced fruity sweet notes and reduced earthy notes, in particular when combined with an increased ratio of (E)-β-damascenone to 2,3-diethyl-5-methylpyrazine.

Roasting coffee in steam is not generally performed as the resulting coffee tends to be sour. However, the roasting conditions used in the process of the current invention surprisingly avoid this sourness, leaving a desirable fine acidity but without unpleasant sourness. In an embodiment, the roast coffee has a titratable acidity of less than 12 mmol sodium hydroxide equivalents per kg roasted coffee, for example less than 11, 10, 9, 8, 7, 6, 5, 4 or 3 mmol sodium hydroxide equivalents per kg roasted coffee.

In an embodiment, the roast coffee of the invention has a weight ratio of total mannose to 3-O-caffeoylquinide of less than 175, for example less than 155, for example less than 135, for example less than 115, for example less than 100, for example less than 80, for example less than 70, for example less than 60. Both ratioed values being expressed as g/kg roasted coffee. 3-O-caffeoylquinide is associated with a desirable bitterness note in coffee. Lower levels of 3-O-caffeoylquinide (and therefore a higher weight ratios of total mannose to 3-O-caffeoylquinide) indicate less of the desirable bitterness characteristic. In the context of the present invention, the term “total mannose” includes mannose which is polymerized, for example in the form of mannan. The total mannose of roast coffee is relatively constant and so variations in weight ratio of total mannose to 3-O-caffeoylquinide are mainly due to the 3-O-caffeoylquinide.

The process of the invention allows the preparation of a coffee with attractive aromas usually associated with light roasting, for example light roasted arabica. Surprisingly these aromas are maintained at relatively high degrees of roasting. In an embodiment the roast coffee has a roast colour of between 30 and 95 CTN, for example between 40 and 80 CTN, for further example between 45 and 75 CTN.

The process of the invention advantageously produces coffee which has high levels of soluble solids or “brew solids”. That is to say, when the coffee is ground and extracted with water, a high proportion of the weight of the coffee is extracted into the water. This allows more efficient use of the coffee raw material and also is advantageous when the coffee is filled into a beverage capsule for use in a beverage preparation device. A coffee with greater soluble solids can be used to produce larger “long cup” coffee beverages, without loss of flavour intensity. Steam roasting maintains moisture levels in the green coffee during part of the coffee roasting process to increase hydrolysis of carbohydrates and so deliver higher levels of brew solids. It is advantageous to be able to achieve this without generating excessive sourness. The brew solids of a coffee may be measured by suspending roast and ground coffee in boiling water and measuring the content of dissolved solids. For example, 5 g of roast and ground coffee of medium grind may be suspended with 100 ml of boiling ultrapure water and stirred for 10 min in a closed vessel. The content of total dissolved solids is measured refractometrically after membrane filtration. In an embodiment, the roast coffee has soluble solids such that 5 g of roast coffee, ground to a particle size D (4,3) between 500 and 600 μm (for example between 540 and 580 μm), suspended in 100 mL of boiling ultrapure water and stirred for 10 min in a closed jar results in a solution having at least 1.3% total solids (for example at least 1.4% total solids, at least 1.5% total solids, at least 1.6% total solids or at least 1.7% total solids), for example as measured refractometrically after membrane filtration. The particle size D (4,3) (sometimes known as the volume mean diameter) may be measured by laser diffraction.

In an embodiment, the roast coffee is contained in a container, the container being for the preparation of a beverage when inserted into a beverage preparation device. The container may for example be a beverage capsule, among other configurations. A roast coffee which has high levels of soluble solids is advantageous for use in beverage capsules as it allows larger “long cup” coffee beverages to be prepared from the same weight of coffee in the capsule, without loss of flavour intensity. Capsules for the preparation of a beverage when inserted into a beverage preparation device have dimensions fixed by the design of the beverage preparation device. Therefore, it is not possible to simply increase the size of the capsule to accommodate more coffee and deliver a long cup.

In an embodiment, the roast coffee is packaged roasted (for example partially roasted) coffee for further roasting. The packaged roasted coffee may be packed in bulk containers, for example for inter-factory transfers. The packaged roasted coffee may be packed in semi-bulk packs to be further roasted at home or in retail outlets such as cafés.

An embodiment of the invention is packaged roasted coffee for further roasting wherein the weight ratio of (E)-β-damascenone to 2,3-diethyl-5-methylpyrazine is greater than 0.7, for example greater than 1.0, for example greater than 1.5, for example greater than 2.0, for example greater than 2.5, for example between 0.7 and 5.0, for further example between 2.0 and 4.0.

In an embodiment, the packaged roasted coffee for further roasting (for example partially roasted coffee) has a roast colour of between 55 and 180 CTN, for example between 75 and 160 CTN, for example between 100 and 150 CTN.

An aspect of the invention is a container for use in a beverage preparation device, the container containing the roast coffee of the invention.

Those skilled in the art will understand that they can freely combine all features of the present invention disclosed herein. In particular, features described for the process of the present invention may be combined with the product of the present invention and vice versa. Further, features described for different embodiments of the present invention may be combined. Where known equivalents exist to specific features, such equivalents are incorporated as if specifically referred to in this specification.

Further advantages and features of the present invention are apparent from the non-limiting examples.

### EXAMPLES

### Example 1: Method for Roasting Coffee

Roasting with steam: 500 grams of coffee were weighed and manually fed to a perforated rotatable drum in a pressurizable chamber. The pressurizable chamber is isolated from the environment by means of ball valves. The coffee is set in motion by rotating the drum. Steam with the desired temperature and pressure is metered into the pressurizable chamber. At the end of desired time of processing, the flow of steam to the pressurizable chamber is stopped and the pressure is reduced quickly to atmospheric pressure. The rotating drum reverses direction and the coffee is metered to the exit of the pressurizable chamber. The processed coffee is then collected through a valve assembly at the bottom of the pressurizable chamber.

Roasting without steam: 350 grams of coffee are loaded into a perforated drawer that can be subjected to a stream of hot air of a desired temperature. The temperature of the coffee beans is measured by means of a temperature probe so that the roasting process may be stopped at an exact coffee bean temperature. At the desired bean end point temperature, the roasted coffee is transferred to a cooling chamber where the roasted coffee is contacted with a stream of ambient temperature air, stopping the roasting process. The sample is then collected from the cooling chamber.

The following green coffee samples were roasted first under superheated steam and then without steam. The conditions and the final colour (as CTN) are in the table below. The robusta coffee was sourced from Vietnam, the arabica coffee from Brazil.

| Sample Name | A1 | A2 | A3 | A4 | A5 | A6 | A7 | A8 |
|---|---|---|---|---|---|---|---|---|
| Coffee type | Robusta | Robusta | Robusta | Robusta | Robusta | Robusta | Robusta | Robusta |

Steam roasting

| | | | | | | | | |
|---|---|---|---|---|---|---|---|---|
| Steam pressure | 15 | 15 | 15 | 12 | 12 | 13 | 14 | 11 |
| [bar] | | | | | | | | |
| Steam temp. [C] | 300 | 300 | 300 | 300 | 300 | 300 | 300 | 300 |
| Steam roasting | 60 | 110 | 110 | 150 | 110 | 130 | 110 | 170 |
| time [s] | | | | | | | | |

Roasting without steam

| | | | | | | | | |
|---|---|---|---|---|---|---|---|---|
| Bean | 200 | 200 | 220 | 210 | 210 | 210 | 210 | 210 |
| temperature [° C.] | | | | | | | | |
| Roasting time [s] | 210 | 210 | 210 | 210 | 210 | 210 | 210 | 210 |
| Final CTN | 113 | 75 | 53 | 58 | 73 | 55 | 59 | 60 |

| Sample Name | A9 | A10 | A11 |
|---|---|---|---|
| Coffee type | Arabica | Arabica | Arabica |

Steam roasting

| | | | |
|---|---|---|---|
| Steam pressure [bar] | 15 | 15 | 15 |
| Steam temp. [C] | 300 | 300 | 300 |
| Steam roasting time [s] | 60 | 110 | 110 |

Roasting without steam

| | | | |
|---|---|---|---|
| Bean temperature [° C.] | 200 | 200 | 220 |
| Roasting time [s] | 210 | 210 | 210 |
| Final CTN | 98 | 65 | 46 |

For comparison, a sample of coffee was prepared using a three-stage process; initially pre-roasting the green beans, then steam roasting and then finally roasting without steam.

| Sample Name | B1 |
|---|---|
| Coffee type | Robusta |

Pre-roasting

| | |
|---|---|
| Bean temperature [° C.] | 210 |
| Roasting time [s] | 180 |

Steam roasting

| | |
|---|---|
| Steam pressure [bar] | 15 |
| Steam temp. [° C.] | 300 |
| Steam roasting time [s] | 60 |

Roasting without steam

| | |
|---|---|
| Bean temperature [° C.] | 200 |
| Roasting time [s] | 210 |
| Final CTN | 51 |

For comparison, samples of green coffee were roasted in two stages as for samples A1-A11, but using a lower temperature (198° C.) saturated steam for the steam roasting stage.

| Sample Name | C1 | C2 | C3 |
|---|---|---|---|
| Coffee type | Robusta | Robusta | Robusta |

Steam roasting

| | | | |
|---|---|---|---|
| Steam pressure [bar] | 15 | 15 | 15 |
| Steam temp. [° C.] | 198 | 198 | 198 |
| Steam roasting time [s] | 60 | 110 | 110 |

Roasting without steam

| | | | |
|---|---|---|---|
| Bean temperature [° C.] | 200 | 200 | 220 |
| Roasting time [s] | 210 | 210 | 210 |
| Final CTN | 130 | 92 | 70 |

For comparison, samples of green coffee were roasted in two stages as for samples A1-A11, but the steam roasting stage was performed with superheated steam but at reduced pressure (8 bar).

| Sample Name | D1 | D2 | D3 |
|---|---|---|---|
| Coffee type | Robusta | Robusta | Robusta |

Steam roasting

| | | | |
|---|---|---|---|
| Steam pressure [bar] | 8 | 8 | 8 |
| Steam temp. [° C.] | 300 | 300 | 300 |
| Steam roasting time [s] | 60 | 110 | 110 |

Roasting without steam

| | | | |
|---|---|---|---|
| Bean temperature [° C.] | 200 | 200 | 220 |
| Roasting time [s] | 210 | 210 | 210 |
| Final CTN | 144 | 124 | 71 |

Samples of green coffee were roasted in a single steam-roasting stage.

| Sample Name | E1 | E2 | E3 |
|---|---|---|---|
| Coffee type | Robusta | Robusta | Robusta |

Steam roasting

| | | | |
|---|---|---|---|
| Steam pressure [bar] | 15 | 15 | 15 |
| Steam temp. [° C.] | 300 | 300 | 300 |
| Steam roasting time [s] | 60 | 110 | 170 |
| Final CTN | 148 | 110 | 67 |

For comparison, samples of green coffee were roasted in two stages as for samples A1-A11, but the steam roasting stage under pressure was followed by steam roasting at essentially atmospheric pressure in the same apparatus.

| Sample Name | F1 | F2 | F3 |
|---|---|---|---|
| Coffee type | Robusta | Robusta | Robusta |

Steam roasting under pressure

| | | | |
|---|---|---|---|
| Steam pressure [bar] | 15 | 15 | 15 |
| Steam temp. [° C.] | 300 | 300 | 300 |
| Steam roasting time [s] | 60 | 110 | 170 |

Steam roasting at atmospheric pressure

| | | | |
|---|---|---|---|
| Steam pressure [bar] | 1 | 1 | 1 |
| Steam temp. [° C.] | 270 | 270 | 270 |
| Steam roasting time [s] | 90 | 90 | 90 |
| Final CTN | 123 | 117 | 59 |

For comparison, samples of green coffee were roasted in a single stage without steam for a duration that resulted in a colour CTN value of 75.

| Sample Name | G1 | G2 | G3 |
|---|---|---|---|
| Coffee type | Robusta | Robusta | Arabica |

Roasting without steam

| | | | |
|---|---|---|---|
| Bean temperature [° C.] | 210 | 220 | 220 |
| Roasting time [s] | 1320 | 670 | 380 |
| Final CTN | 75 | 75 | 75 |

Technical tasting: The roasted coffees were prepared for tasting with a filter coffee machine. 50 g of coffee was extracted with 1000 ml water at a temperature of 100° C. Technical tasting was performed by 6 people. Each person noted their comments on the taste and aroma of each sample.

### Example 2: Aroma Analysis

Absolute contents (mg/kg of roasted coffee) of the aroma compounds of interest were quantified in the roast and ground coffee (R&G) after suspension in water using isotopically labelled standards in conjunction with solid phase microextraction and gas chromatography-mass spectrometry (SPME-GC-MS/MS) analysis.

### Sample Preparation

5 g of roast and ground coffee sample was placed in a screw cap flask, suspended with 100 mL of boiling water and, after closing, stirred for 10 min. After cooling on ice, the obtained slurry was spiked with defined quantities of labeled isotopes of the analytes, and an aliquot of sample (7 ml) was transferred into silanised glass vials that were sealed (standard 20 ml vials used for headspace/SPME analysis).

### Extraction of Aroma

The sample was equilibrated for 60 min at room temperature. Aroma compounds were then extracted from the headspace by solid phase microextraction (SPME) at 40° C. during 10 min (2 cm fiber, 50/30 μm StableFlex, coated with PDMS/DVB/Carboxen; Supelco, Buchs, Switzerland), and thermally desorbed into the split-splitless injector (in split-mode; split of 2) heated at 240° C. for 10 min.

### GC-MS/MS Analysis of Compounds of Interest

Separation was carried out on a 60 m×0.25 mm×0.25 μm polar DB-624UI column (Agilent, Basel, Switzerland) using an Agilent 7890B gas chromatograph (Agilent, Basel, Switzerland). Helium was used as carrier gas with a constant flow of 1.2 mL/min. Following oven program was applied: initial temperature of 40° C. was held for 6 min, then raised to 240° C. at 6° C./min, and final temperature held for 10 min. Mass spectrometry was performed on an Agilent 7010 Triple Quad mass spectrometer (Agilent, Basel, Switzerland). Chromatograms were processed using the Agilent MassHunter software.

### Aroma Results

Absolute contents (mg/kg of roasted coffee) and ratios of the aroma compounds of interest

| Sample Name | A1 | A2 | A3 | A4 | A5 | A6 | A7 | A8 |
|---|---|---|---|---|---|---|---|---|
| dimethyl trisulfide | 0.0151 | 0.0126 | 0.0132 | 0.0231 | 0.0230 | 0.0443 | 0.0303 | 0.0171 |
| (E)-β-damascenone | 0.227 | 0.119 | 0.099 | 0.106 | 0.115 | 0.104 | 0.097 | 0.123 |
| 2,3-diethyl-5-methylpyrazine | 0.057 | 0.060 | 0.060 | 0.078 | 0.085 | 0.075 | 0.071 | 0.079 |
| Ratios | | | | | | | | |
| (E)-β-damascenone/2,3- | 4.0 | 2.0 | 1.7 | 1.4 | 1.3 | 1.4 | 1.4 | 1.6 |
| diethyl-5-methylpyrazine | | | | | | | | |
| dimethyl trisulfide/2,3- | 0.27 | 0.21 | 0.22 | 0.30 | 0.27 | 0.59 | 0.43 | 0.22 |
| diethyl-5-methylpyrazine | | | | | | | | |

| Sample Name | A9 | A10 | A11 | B1 |
|---|---|---|---|---|
| dimethyl trisulfide | 0.0111 | 0.0146 | 0.0150 | 0.0084 |
| (E)-β-damascenone | 0.157 | 0.085 | 0.081 | 0.062 |
| 2,3-diethyl-5-methylpyrazine | 0.040 | 0.034 | 0.033 | 0.063 |
| Ratios | | | | |
| (E)-β-damascenone/2,3- | 3.9 | 2.5 | 2.5 | 1.0 |
| diethyl-5-methylpyrazine | | | | |
| dimethyl trisulfide/2,3- | 0.28 | 0.43 | 0.46 | 0.13 |
| diethyl-5-methylpyrazine | | | | |

| Sample Name | C1 | C2 | C3 | D1 | D2 | D3 | E1 |
|---|---|---|---|---|---|---|---|
| dimethyl trisulfide | 0.0095 | 0.0071 | 0.0116 | 0.0143 | 0.0099 | 0.0231 | 0.0072 |
| (E)-β-damascenone | 0.216 | 0.197 | 0.190 | 0.240 | 0.222 | 0.217 | 0.199 |
| 2,3-diethyl-5-methylpyrazine | 0.051 | 0.056 | 0.061 | 0.119 | 0.113 | 0.139 | 0.059 |
| Ratios | | | | | | | |
| (E)-β-damascenone/2,3- | 4.3 | 3.5 | 3.1 | 2.0 | 2.0 | 1.6 | 3.4 |
| diethyl-5-methylpyrazine | | | | | | | |
| dimethyl trisulfide/2,3- | 0.19 | 0.13 | 0.19 | 0.12 | 0.09 | 0.17 | 0.12 |
| diethyl-5-methylpyrazine | | | | | | | |

| Sample Name | E2 | E3 | F1 | F2 | F3 | G1 | G2 | G3 |
|---|---|---|---|---|---|---|---|---|
| dimethyl trisulfide | 0.0054 | 0.0066 | 0.0050 | 0.0030 | 0.0035 | 0.0209 | 0.0321 | 0.0253 |
| (E)-β-damascenone | 0.176 | 0.166 | 0.216 | 0.135 | 0.110 | 0.146 | 0.153 | 0.092 |
| 2,3-diethyl-5-methylpyrazine | 0.061 | 0.062 | 0.062 | 0.052 | 0.036 | 0.285 | 0.270 | 0.185 |
| Ratios | | | | | | | | |
| (E)-β-damascenone/2,3- | 2.9 | 2.7 | 3.5 | 2.6 | 3.1 | 0.5 | 0.6 | 0.5 |
| diethyl-5-methylpyrazine | | | | | | | | |
| dimethyl trisulfide/2,3- | 0.09 | 0.11 | 0.08 | 0.06 | 0.10 | 0.07 | 0.12 | 0.14 |
| diethyl-5-methylpyrazine | | | | | | | | |

### Example 3: Soluble Solids and Acidity Analysis

Soluble solids: Samples of each coffee were ground at level 5.5 on a Ditting coffee grinder (particle sizes D (4,3) between 500 and 600 μm). 5 g of each ground coffee were suspended in 100 ml of boiling ultrapure water and stirred for 10 min in a closed vessel. The content of total dissolved solids was measured refractometrically using a VST LAB coffee III refractometer after membrane filtration with a syringe filter (polyethersulfone, 0.2 μm).

Acidity: 10 g of roast and ground coffee were suspended with 200 ml of ultrapure water, and after adding 2 droplets of anti-foaming silicone oil heated to boiling. After 5 min of boiling under agitation and cooling down, the evaporation losses were compensated by addition of ultrapure water. The suspension was filtrated through a pleated filter (SS 597/2), and 50 ml of filtrate were transferred to an 814 Sample Processor (Metrohm). Using a 905 Titrando system (Metrohm), a titration to pH 6.60 was performed with an aqueous sodium hydroxide solution (0.1 M), and the results were expressed as mmol sodium hydroxide equivalents per kg roasted coffee.

| Sample | A2 | E3 | F3 | G1 |
|---|---|---|---|---|
| Soluble solids/% Tc | 1.78 | 2.03 | 1.85 | 1.12 |
| Acidity by titration | 9.2 | 16.8 | 15.0 | 2.3 |
| Final CTN | 75 | 67 | 59 | 75 |

It can be seen that, for similar roast levels, the invention (exemplified here by A2) provides a high level of soluble solids, comparable with that obtained by single-stage steam roasting (E3) or steam roasting under pressure followed by steam roasting at essentially atmospheric pressure (F3) but with lower acidity.

This was confirmed by the technical tasting. Comments for Sample A2 included “roasty”, “cooked fruit” and “fine acidity”. Samples E3 and F3 were described as having “cooked fruit” notes but also “high acidity”.

Sample G1 was described as “earthy”, with “burnt”, and “rubber” notes. These characteristics of darkly roasted robusta coffee were not commented on for the robusta samples roasted to similar CTN numbers by the process of the invention.

Samples A4, A5, A6, A7 and A8 according to the invention provided a higher level of soluble solids than the conventionally roasted sample G1, but had low acidity.

| Sample | A4 | A5 | A6 | A7 | A8 |
|---|---|---|---|---|---|
| Soluble solids/% Tc | 1.46 | 1.33 | 1.39 | 1.47 | 1.38 |
| Acidity by titration | 2.2 | 2.0 | 2.3 | 2.3 | 2.4 |
| Final CTN | 58 | 73 | 55 | 59 | 60 |

### Example 4: Non-Volatile Component Analysis

The analysis of chlorogenic acid lactones was performed on a QTRAP 6500 LC-MS/MS system (AbSciex), operating in multiple reaction monitoring (MRM) mode.

Prior to the instrumental analysis, the samples prepared as in Example 2 were diluted 1:10 with ultrapure water.

To perform the chromatography, an Agilent 1290 Infinity II system (Agilent) was used, equipped with a binary G7104A pump, an G7167B auto sampler cooled to 4° C., and a G7116B column oven heated to 30° C. The samples (5 μL) were injected in a triplicate determination onto a Kinetex Phenyl-Hexyl 100 mm×2.1 mm×1.7 μm column (Phenomenex), using 0.1% aqueous formic acid (A) and 0.1% formic acid in acetonitrile (B) as mobile phase. At flow rate of 0.4 mL/min, the following gradient was applied: 0% B for 1 min, up to 35% B in 10 min, then in 2 min to 100% B and kept for 3.5 min before going to starting conditions in 0.5 min and kept for 3 min.

The LC-system was coupled with a QTRAP 6500 mass spectrometer (AbSciex), using Analyst (version 1.7.1) as software. Thereby, the source conditions for application of the positive ESI mode were the following: gas 1:55 psi, gas 2:65 psi, curtain gas: 35 psi, source temperature: 550° C., ion spray voltage floating: 5500 V. For the MS/MS detection in multiple reaction monitoring (MRM) mode, the following mass transitions were applied, with each one quantifier (Q) and one qualifier mass transition per compound:

Applied MS/MS detection parameters in multiple reaction monitoring (MRM) mode with Q1=Precursor Ion m/z, Q3=Fragmentation Ion m/z, DP=Declustering Potential, EP=Entrance Potential, CE=Collision Energy, CXP=Collision Cell Exit Potential.

| Name | Q1 | Q3 | DP | EP | CE | CXP |
|---|---|---|---|---|---|---|
| 5-Chlorogenic acid Q | 355 | 163 | 106 | 10 | 19 | 18 |
| 5-Chlorogenic acid | 355 | 267 | 106 | 10 | 27 | 14 |
| 3-O-Caffeoylquinide Q | 337 | 163 | 46 | 10 | 19 | 10 |
| 3-O-Caffeoylquinide | 337 | 89 | 46 | 10 | 69 | 4 |

Data treatment was performed with MultiQuant software (AbSciex, version 3.0.2), and the concentrations were determined based on an external calibration with 5-chlorogenic acid, diluting stepwise a stock solution (103 mg/L), and expressed as chlorogenic acid equivalents. The calibration was performed over the calibration range 0 to 15 mg/L.

### Analysis of Total Mannose

The analysis of total mannose levels was performed on an ICS-5000 ion-chromatography (Thermo Fisher Scientific), applying pulsed amperometric detection (PAD).

Roasted coffee was cryo-ground to a particle size of 100 μm, and 50 mg were transferred into a hydrolysis tube. 200 μL of sulfuric acid (72%) were added prior to vortexing. A first hydrolysis was performed for 2 h at ambient temperature, and after addition of 2.3 mL of ultrapure water and vortexing, a second hydrolysis was performed for 3 h at 100° C. After cooling down to ambient temperature, the pH of the solution was adjusted to pH 7 with an aqueous sodium hydroxide solution (1 M). The volume was filled up to 250 mL with ultrapure water and the solution diluted 1:4. After membrane filtration samples were transferred onto a Sep-Pak C18 cartridge (Waters). Conditioning was carried out by flushing with 2 ml of methanol, followed by 3 ml of ultrapure water.

An aliquot of 1 mL was transferred into a sample vial, prior to injection (10 μL) onto a PA100 column (Thermo Fisher Scientific) in an ICS-5000 equipment (Thermo Fisher Scientific), using ultrapure water (A) and 1 M aqueous sodium hydroxide (B) as mobile phase. At flow rate of 1 mL/min, the following gradient was applied: 0% B for 32 min, up to 25% B in 5 min and kept for 5 min before going to starting conditions in 5 min and kept for 10 min. The detection was performed with a pulsed amperometric detection, supported by an additional post-column flow of 0.3 M aqueous sodium hydroxide of 0.5 mL/min.

For the data treatment, Chromeleon software was applied. The concentrations were determined based on an external calibration with mannose, diluting stepwise an aqueous stock solution of 96 mg/L.

### Non-Volatile Results

Total mannose content (g/100 g roasted coffee), 3-O-caffeoylquinide (expressed as mg chlorogenic acid equivalents/kg roasted coffee) and ratio of these each as g/kg roasted coffee

| Sample | A1 | A2 | A3 | A4 | A5 | A6 | A7 | A8 |
|---|---|---|---|---|---|---|---|---|
| Total mannose | 19.5 | 16.9 | 17.9 | 18.1 | 18.4 | 18.0 | 18.4 | 19.2 |
| 3-O-caffeoylquinide | 1342 | 1785 | 1310 | 1881 | 2052 | 1970 | 1983 | 2028 |
| Ratio | | | | | | | | |
| Total mannose/3-O | 145 | 95 | 137 | 96 | 90 | 91 | 93 | 95 |
| caffeoylquinide | | | | | | | | |

| Sample | A9 | A10 | A11 | B1 |
|---|---|---|---|---|
| Total mannose | 19.1 | 18.0 | 18.2 | 17.2 |
| 3-O-caffeoylquinide | 1177 | 1328 | 1095 | 744 |
| Ratio | | | | |
| Total mannose/3-O- | 162 | 136 | 166 | 231 |
| caffeoylquinide | | | | |

| Sample | C1 | C2 | C3 | D1 | D2 | D3 | E1 |
|---|---|---|---|---|---|---|---|
| Total mannose | 20.8 | 19.0 | 18.6 | 19.3 | 18.1 | 18.9 | 21.3 |
| 3-O-caffeoylquinide | 1080 | 1949 | 1526 | 942 | 1641 | 1313 | 483 |
| Ratio | | | | | | | |
| Total mannose/3-O- | 193 | 98 | 122 | 205 | 110 | 144 | 441 |
| caffeoylquinide | | | | | | | |

| Sample | E2 | E3 | F1 | F2 | F3 | G1 | G2 | G3 |
|---|---|---|---|---|---|---|---|---|
| Total mannose | 17.7 | 19.6 | 20.2 | 20.1 | 19.4 | 18.6 | 17.5 | 19.9 |
| 3-O-caffeoylquinide | 1161 | 1145 | 626 | 1129 | 1000 | 348 | 170 | 1478 |
| Ratio | | | | | | | | |
| Total mannose/3-O- | 152 | 171 | 323 | 178 | 194 | 534 | 1028 | 134 |
| caffeoylquinide | | | | | | | | |

It can be seen that sample A2 (a robusta coffee roasted first under superheated steam and then without steam), has a lower weight ratio of total mannose to 3-O-caffeoylquinide than sample G2 (a robusta coffee simply roasted without steam) and so has a greater level of pleasant coffee bitterness, even though both were roasted to the same CTN of 75.

1. A process for roasting coffee beans comprising roasting unroasted coffee beans in the presence of superheated steam at a pressure greater than 9.5 bar for a period between 20 and 900 seconds followed by roasting without steam at a bean temperature of between 180° C. and 260° C. for a period between 20 and 1200 seconds.

2. The process of claim 1 wherein the unroasted coffee beans have not been heated to temperatures above 110° C.

3. The process of claim 1 wherein the roasting without steam is performed in a fluidized bed roaster or a paddle roaster.

4. The process of claim 1 wherein the beans roasted in the presence of superheated steam are packed into containers and transported to at least one other location before being roasted without steam.

5. The process of claim 1 wherein the beans after roasting without steam are blended with further coffee beans that have been roasted under different conditions.

6. A roast coffee having a weight ratio of (E)-β-damascenone to 2,3-diethyl-5-methylpyrazine of greater than 0.7.

7. The roast coffee of claim 6 wherein the weight ratio of dimethyl trisulfide to 2,3-diethyl-5-methylpyrazine is greater than 0.2.

8. The roast coffee of claim 6 having a titratable acidity of less than 12 mmol sodium hydroxide equivalents per kg roasted coffee.

9. The roast coffee of claim 6 having a weight ratio of total mannose to 3-O-caffeoylquinide of less than 175.

10. The roast coffee of claim 6 having a roast colour of between 30 and 95 CTN.

11. The roast coffee of claim 6 having soluble solids such that 5 g of roast coffee, ground to a particle size D (4,3) between 500 and 600 μm, suspended in 100 mL of boiling ultrapure water and stirred for 10 min in a closed jar results in a solution having at least 1.3% total solids.

12. The roast coffee according to claim 6 being packaged roasted coffee for further roasting.

13. The roast coffee of claim 12 wherein the coffee has a roast colour of between 55 and 180 CTN.

14. (canceled)
